(19) United States
(12) Patent Application Publication
(10) Pub. No.: US 2007/0091066 A1
(43) Pub. Date: Apr. 26, 2007

(54) Slide pad system and method with hybrid mode

(76) Inventor: Jonah Harley, Mountain View, CA (US)

Correspondence Address: AVAGO TECHNOLOGIES, LTD., P.O. BOX 1920, DENVER, CO, 80201-1920, US

(21) Appl. No.: 11/256,882

(22) Filed: Oct. 24, 2005

(51) Int. Cl. G09G 5/08

(52) U.S. Cl. 345/157

(57) ABSTRACT

A method comprising detecting a displacement of a slide disk relative to a frame and generating output information using first information configured to cause a pointer in a display to move to a position associated with the displacement and second information configured to cause the pointer in the display to move at a velocity associated with the displacement is provided.

### BACKGROUND

Various input devices exist for navigating a pointer in a display. Examples of such devices include a mouse, a joystick, and a touchpad. These devices receive inputs from a user and, in conjunction with a host, translate the inputs to move the pointer within the display. The input devices may also have a selection mechanism such as a button to allow the user to perform functions in the display.

Each type of input device may serve a useful function in allowing a user to interact with a host device. Because of design constraints of a host such as a mobile telephone, a particular input device may not be suited for a particular host or type of user interaction with the host. For example, size limitations of a host may prevent the use of certain types of input devices. It would be desirable to provide an input device that provides as much functionality as possible for a host.

### SUMMARY

One exemplary embodiment provides a method comprising detecting a displacement of a slide disk relative to a frame and generating output information using first information configured to cause a pointer in a display to move to a position associated with the displacement and second information configured to cause the pointer in the display to move at a velocity associated with the displacement.

### BRIEF DESCRIPTION OF THE DRAWINGS

FIG. 1 is a schematic diagram illustrating one embodiment of a slide pad system.

FIG. 2 is a block diagram illustrating one embodiment of a slide pad system coupled to a host.

FIG. 3A is a schematic diagram illustrating a top view of one embodiment of selected portions of a slide pad.

FIG. 3B is a schematic diagram illustrating a cross-section view of one embodiment of selected portions of a slide pad.

FIG. 4 is a block diagram illustrating one embodiment of an output generation module.

FIG. 5 is a flow chart illustrating one embodiment of a method for generating output information with a slide pad system.

FIGS. 6A-6D are graphs illustrating an example of generating output information with a slide pad system.

FIG. 7 is a flow chart illustrating another embodiment of a method for generating output information with a slide pad system.

FIG. 8 is a graph illustrating one embodiment of a dead zone

FIG. 9 is a schematic diagram illustrating one embodiment of a host that includes a pointing system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

As described herein, a slide pad system and method are provided. The system includes a slide disk disposed in a frame and a control unit. A user moves the slide disk in two directions (e.g., the x and y directions) relative to the frame to adjust a pointer location in a display device of a host and applies pressure the slide disk in a third direction (e.g., the z direction) relative to the frame to activate the slide pad system and cause one or more functions to be performed. The control unit determines output information based on the movement of the slide disk in the first two directions, and determines a finger pressure and a selection state based on the applied pressure in the third direction. The control unit provides the output information and the selection state to a host for use in adjusting a pointer position in a display and performing functions.

In embodiments described below, the control unit generates the output information in a hybrid mode of operation using a combination of position information and rate information in accordance with displacement of the slide disk relative to the frame in the x and y directions. The position information is configured to cause a pointer in a display to move to a position associated with a displacement of the slide disk relative to the frame, and the rate information is configured to cause the pointer in the display to move at a velocity associated with the displacement of the slide disk relative to the frame. In one embodiment, the control unit generates the output information by summing the position information and the rate information.

In a slide pad system, the slide disk has a limited, i.e., relatively small, space to be displaced with the frame. The hybrid mode enhances the ability of the slide pad system to cause a pointer to move in a relatively large display, e.g., a computer screen, despite the limited space in which the slide disk may be moved in the frame. By combining the position information and the rate information in the hybrid mode, the slide pad system combines features of a mouse and a joystick. For example, the position information provides precision and responsiveness similar to a mouse, and the rate information provides an ability of to move across a relatively large display similar to a joystick.

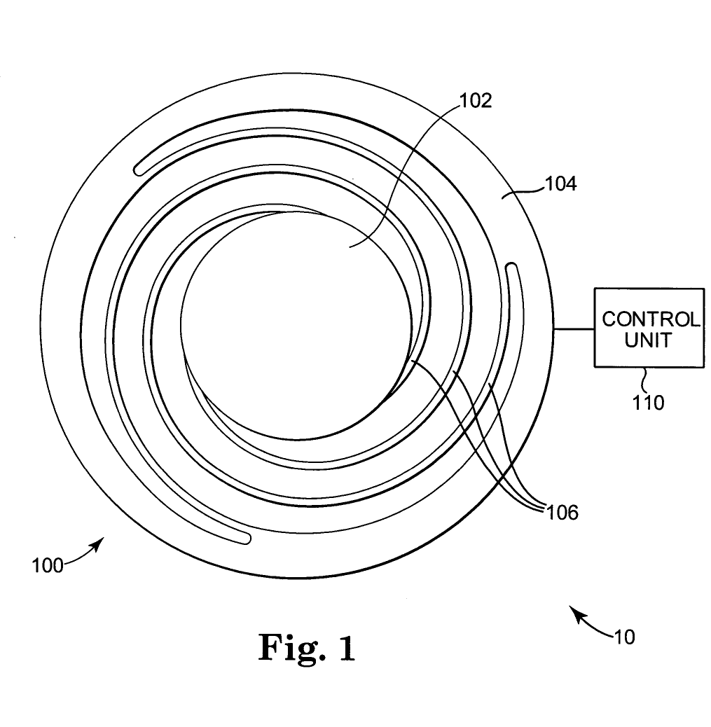

FIG. 1 is a schematic diagram illustrating one embodiment of a slide pad system 10. Slide pad system 10 includes a slide pad 100 coupled, directly or indirectly, to a control unit 110. Slide pad 100 includes a slide disk 102, a frame 104, and a plurality of spring devices 106 connected, directly or indirectly, to slide disk 102 and frame 104.

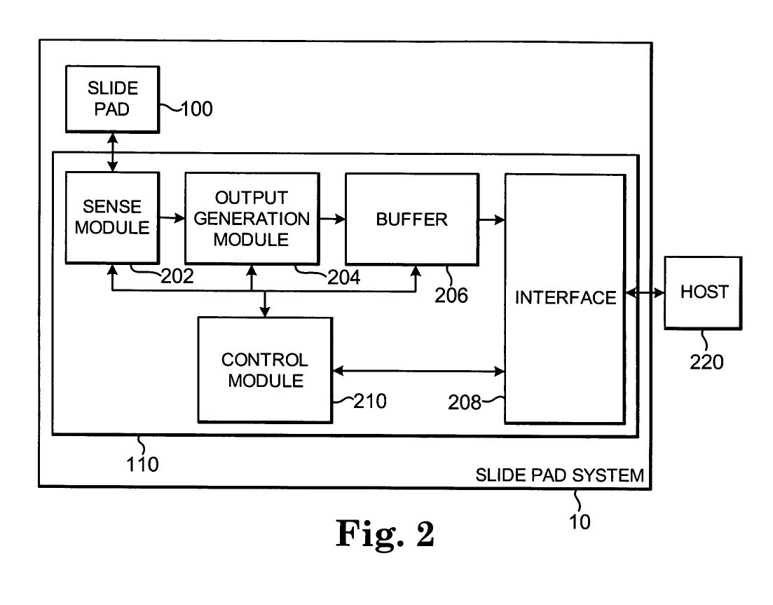

Slide pad system 10 provides output information to a host (e.g., host 220 as shown in FIG. 2) in response to inputs from a user. The user provides inputs by moving slide disk 102 in two directions relative to frame 104. These two directions are referred to herein as the x and y directions and define a hypothetical plane that includes frame 104. Accordingly, the x and y directions are parallel to the hypothetical plane. Slide pad system 10 converts the inputs in the x and y directions to output information and provides the output information to the host to cause a pointer (e.g., a cursor) to be adjusted in a display device of the host. The user also provides inputs by applying pressure to slide disk 102 in a third direction. The third direction is referred to herein as the z direction and is perpendicular to the hypothetical plane that includes frame 104. Slide pad system 10 converts the inputs in the z direction to finger pressure information and a selection state. Slide pad system 10 processes the finger pressure information to activate slide pad system 10 in response to the finger pressure information exceeding a threshold, e.g., in response to detecting that a user is touching slide disk 102 to generate a minimum amount of finger pressure. Slide pad system 10 provides the selection state to the host to cause one or more functions to be performed by the host.

Spring devices 106 operate to bias slide disk 102 toward a center position in the x and y directions. The user moves slide disk 102 within frame 104 by applying sufficient pressure on slide disk 102 in the x and/or y direction to overcome the resistance of spring devices 106. When the resistance of spring devices 106 exceeds the x and/or y direction pressure applied to slide disk 102 by the user (e.g., when the user releases the x and/or y direction pressure on slide disk 102), spring devices 106 cause slide disk 102 to return to or toward the center position in the x and y directions.

In the embodiment of FIG. 1, spring devices 106 form a plurality spiral-shaped portions that connect slide disk 102 to frame 104. In another embodiment, spring devices 106 form a plurality of interconnected, concentric ridges (not shown) that connect slide disk 102 to frame 104. In other embodiments, spring devices 106 form any other suitable structure configured to bias slide disk 102 toward a center position of frame 104 in the x and y directions.

One or more internal spring devices (not shown) operate to bias slide disk 102 toward a center position in the z direction. The internal spring device may comprise a bi-stable dome switch (not shown), for example. The user causes slide pad system 100 to be activated to cause output information to be provided to the host by applying a minimum amount of pressure, e.g., finger pressure, on slide disk 102 in the z direction. The user also causes functions of the host to be performed by applying and/or releasing pressure on slide disk 102 in the z direction according to various thresholds. For example, the user may apply and release pressure on slide disk 102 any number of times to cause one or mores clicks of varying durations to be performed. When the resistance of the internal spring devices exceeds the z direction pressure applied to slide disk 102 by the user (e.g., when the user releases the z direction pressure on slide disk 102), spring devices 106 cause slide disk 102 to return to or toward the center position in the z direction.

Control unit 110 measures the amount of movement of slide device 102 in the x, y, and z directions. From the measurements in the x and y directions, control unit 110 generates the output information and provides the output information to the host. The host adjusts the position of a pointer, such as a cursor, using the output information. From the measurements in the z direction, control unit 110 detects a minimum threshold of pressure to detect that a user may provide inputs in the x, y, and/or z directions. In addition, control unit 110 generates the selection state from the measurements in the z direction and provides the selection state to the host. The host causes one or more functions to be performed using the selection state.

In one embodiment, slide pad system 10 operates according to one or more modes of operation. The modes of operation may include a mouse mode, a one-to-one mode, a joystick mode, and a hybrid mode.

In the mouse mode, slide pad system 10 provides output information to the host in the form of position information to cause the pointer of the host to move to a position associated with a displacement of slide disk 102 relative to frame 104 in the x and/or y directions XX. In the mouse mode, slide pad system 10 maps the displacement to a position of the pointer in a display of the host. When the user is moving slide disk 102 relative to frame 104, slide pad system 10 provides output information to cause the pointer of the host to move in the direction of the displacement at a rate the is proportional to the rate of displacement. When the user stops moving slide disk 102 or allows slide disk 102 to return to the center position of frame 104, slide pad system 10 provides output information to cause the pointer of the host to remain in place, i.e., not move back to a neutral position in the display of the host.

In the one-to-one mode, slide pad system 10 provides output information to the host to cause the pointer of the host to track the displacement of slide disk 102 relative to frame 104 in the x and/or y directions. Like mouse mode, slide pad system 10 maps the displacement to a position of the pointer in a display of the host. When the user allows slide disk 102 to return to the center position of the x and y directions, however, slide pad system 10 provides output information to cause the pointer of the host to move back to a neutral position in the display of the host. The neutral position in the display corresponds to the center position of the x and y directions of slide pad system 10.

In the joystick mode, slide pad system 10 provides output information to the host in the form of rate information to cause the pointer of the host to move at a velocity associated with the displacement of slide disk 102 relative to frame 104 in the x and/or y directions. In the joystick mode, slide pad system 10 maps the displacement to a velocity of the pointer in a display of the host. The further that the user displaces slide disk 102 from the center position of the x and y directions, the faster the pointer moves in the display of the host and vice versa. When the user allows slide disk 102 to return to the center position of frame 104 (i.e., the zero direction and zero velocity position of slide pad system 10 in joystick mode), slide pad system 10 provides output information to cause the pointer of the host to remain in place, i.e., not move back to a neutral position in the display of the host.

In the hybrid mode, slide pad system 10 provides output information to the host that represents a combination of the position information of the mouse mode and the rate information of the joystick mode. In one embodiment, the output information represents a sum of the position information and the rate information. Accordingly, slide pad system 10 provides output information to the host to cause the pointer of the host to move in a direction and a rate determined by the combination of the position information and the rate information.

In other embodiments, slide pad system 10 operates in other modes of operation or according to a single mode of operation.

FIG. 2 is a block diagram illustrating one embodiment of slide pad system 10 coupled, directly or indirectly, to host 220. In the embodiment of FIG. 2, control unit 110 includes a sense module 202, an output generation module 204, a buffer 206, an interface 208, and a control module 210.

Sense module 202 detects the displacement of slide disk 102 relative to frame 104 in the x, y, and z directions. Sense module 202 provides information associated with the displacement to output generation module 204. Output generation module 204 receives the displacement information from sense module 202 and generates output information, finger pressure information, and selection information according to the displacement information and parameters set by control module 210. Output generation module 204 provides the output information and selection information to host 220 using buffer 206 and interface 208. Control module 210 controls the operation of sense module 202, output generation module 204, buffer 206, and interface 208.

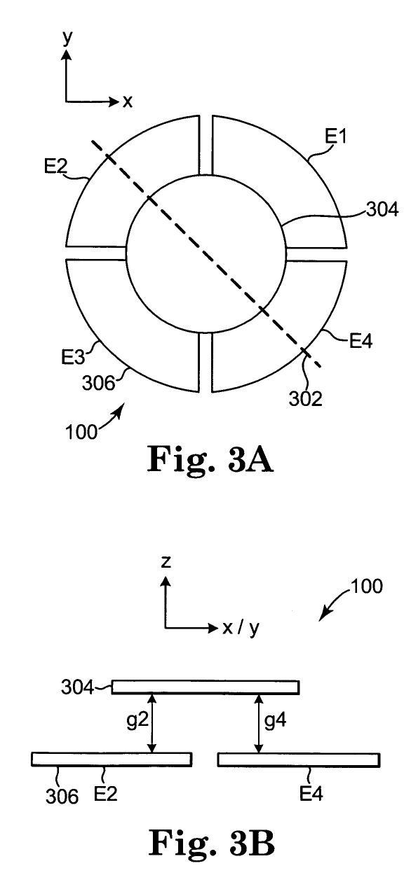

Additional details of the operation of slide pad 100 and sense module 202 in measuring displacements in the x, y, and z directions are described with reference to FIGS. 3A and 3B.

FIG. 3A is a diagram illustrating a top view of one embodiment of selected portions of slide pad 100, and FIG. 3B is a diagram illustrating a cross-section view of selected portions of one embodiment of slide pad 100 along an axis 302 shown in FIG. 3A. Slide pad 100 includes a spring/sense plate 304 that is moved by the user in the x and y directions with respect to electrodes E1, E2, E3, and E4.

As shown in the cross-section in FIG. 3B, electrodes E2 and E4 are set in a first plane formed in the x and y directions. Electrodes E1 and E3 are also set in the first plane (not shown in FIG. 3B). Spring/sense plate 304 is set in a second plane formed in the x and y directions such that the second plane is displaced from the first plane as indicated by a gap g2 between spring/sense plate 304 and electrode E2 and a gap g4 between spring/sense plate 304 and electrode E4.

Sense module 202 measures the capacitances between electrodes E1, E2, E3, and E4 and spring/sense plate 304 to determine the displacement of slide disk 102 relative to frame 104 in the x and y directions. The displacement of slide disk 102 relative to frame 104, as shown in FIG. 1, corresponds to the position of spring/sense plate 304 with respect to electrodes E1, E2, E3, and E4. Accordingly, output generation module 204 generates output information in response to the position of spring/sense plate 304 with respect to electrodes E1, E2, E3, and E4 in the x and y directions using the displacement measurements from sense module 202.

Referring back to FIG. 2, control unit 110 selectively operates slide pad system 10 in the mouse, one-to-one, joystick, and hybrid modes of operation. In the embodiment of FIG. 2, control module 204 provides mode select signals to sense module 202 and/or output generation unit 204 to cause output information to be generated for the selected mode of operation.

In the hybrid mode of operation, control unit 110 detects a displacement of slide disk 102 relative to frame 104 in the x and/or y directions and generates output information using position information and rate information. In the embodiment of FIG. 2, output generation module 204 generates the position information and the rate information such that the position information is configured to cause a pointer in a display of host 220 to move to a position associated with the displacement and the rate information is configured to cause the pointer in the display of host 220 to move at a velocity associated with the displacement.

In one embodiment, output generation module 204 generates the output information by summing the position information and rate information. In other embodiments, output generation module 204 generates the output information by summing varying proportions of the position information and rate information. The proportions used by output generation module 204 in generating the output information may vary with the amount of displacement. For example, when the displacement is below a threshold, e.g., slide disk 102 is in a dead zone as described below with reference to FIG. 8, output generation module 204 may generate the output information using the position information and not the rate information. In other circumstances, output generation module 204 may generate the output information using the rate information and not the position information, or output generation module 204 may generate the output information using the any proportions of the position information and the rate information, respectively. In one embodiment, output generation module 204 separately generates the position information and the rate information using separate gain values. The gain values may be provided to output generation module 204 by control module 210 and may be used to increase or decrease the proportion of the position information and the rate information used in generating the output information.

In one embodiment, control module 210 causes output generation module 204 to generate output information only in response to detecting that a minimum amount of finger pressure is applied to slide disk 102, i.e., the displacement of slide disk 102 in the z direction exceeds a threshold. If the minimum amount of finger pressure is not applied to slide disk 102, control module 210 causes output generation module 204 to operate in an idle state and not generate output information or selection information.

In one embodiment, components of control unit 110 such as output generation module 204 comprise a one or more processors (not shown) and firmware (not shown) configured to control the operation of control unit 110 including generating and processing the output information and selection information and providing the output information and selection information to host 220. The firmware is stored in a storage medium (not shown) accessible by the processor. The firmware may also be stored on other media including portable media such as a CD-ROM prior to being stored in the storage medium accessible by the processor. In other embodiments, components of control unit 110 include any other combination of hardware and/or software components.

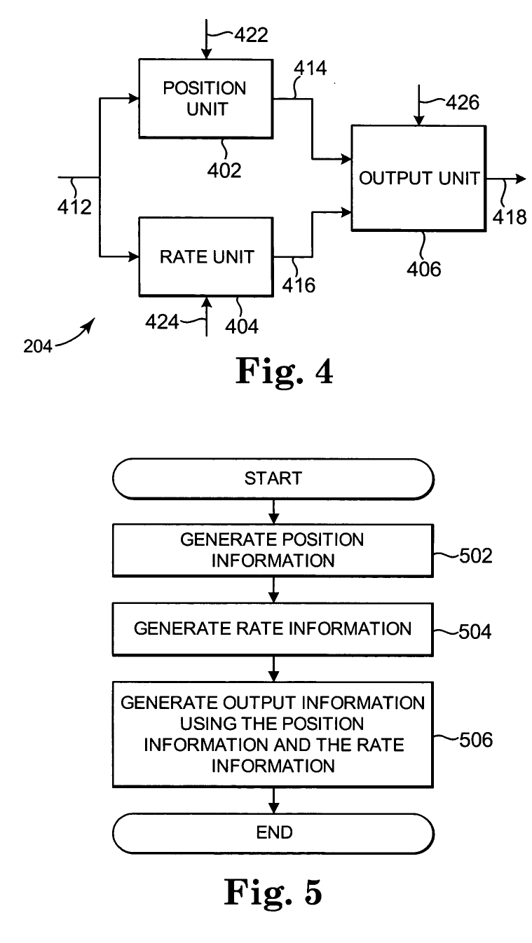

FIG. 4 is a block diagram illustrating one embodiment of output generation module 204. In the embodiment of FIG. 4, output generation module 204 includes a position unit 402, a rate unit 404, and an output unit 406. FIG. 5 is a flow chart illustrating one embodiment of a method for generating output information with slide pad system 10. The operation of the embodiment of FIG. 4 will now be described with reference to FIG. 5.

In operation, position unit 402 and rate unit 404 receive signal 412 from sense module 202 that indicates the displacement of slide disk 102 relative to frame 104 in the x and/or y directions. Position unit 402 generates position information using the displacement, as indicated in a block 502, and provides the position information to output unit 406 using a signal 414. Rate unit 404 generates rate information using the displacement, as indicated in a block 502, and provides the rate information to output unit 406 using a signal 416. Output unit 406 generates output information using the position information and the rate information, as indicated in a block 504, and provides the output information to buffer 206 using a signal 418.

The method of FIG. 5 may be repeated either continuously in cycles (e.g., 120 Hz) or at selected times to generate updated output information and provide the updated output information to host 220. The selection state may be generated along with the output information in each cycle.

In the embodiments of FIGS. 4 and 5, position unit 402 generates the position information such that the position information is configured to cause a pointer in a display of host 220 to move to a position associated with a displacement. To do so, position unit 402 applies any suitable function to the displacement such that the position information is configured to cause the pointer in the display of host 220 to move to a position that is proportional to the displacement. By doing so, position unit 402 maps the displacement to the position of the pointer in the display of host 220. In one embodiment, control module 210 provides a gain to position unit 402 using a signal 422. In this embodiment, position unit 402 applies the gain parameter to the function to generate the position information. To increase the proportion of position information in the output information, control module 210 may increase the gain provided to position unit 402, and vice versa.

Rate unit 404 generates the rate information such that the rate information is configured to cause the pointer in the display of host 220 to move at a velocity associated with the displacement. To do so, rate unit 404 applies any suitable function to the displacement such that the rate information is configured to cause the pointer in the display of host 220 to move at a velocity that is proportional to the displacement. By doing so, rate unit 404 maps the displacement to the velocity of the pointer in the display of host 220. In one embodiment, control module 210 provides a gain to rate unit 404 using a signal 424. In this embodiment, rate unit 404 applies the gain parameter to the function to generate the rate information. To increase the proportion of rate information in the output information, control module 210 may increase the gain provided to rate unit 404, and vice versa.

Output unit 406 generates the output information using the position information and the rate information. In one embodiment, output unit 406 generates the output information by summing the position information and rate information. In other embodiments, output unit 406 generates the output information by summing varying proportions of the position information and rate information. The proportions may vary with the amount of displacement. Control module 210 may also provide a signal 426 to output unit 406 to adjust the proportions of the position information and the rate information based on the amount of displacement or other parameters. For example, when the displacement is below a threshold, e.g., slide disk 102 is in a dead zone as described below with reference to FIG. 8, output unit 406 may generate the output information using the position information and not the rate information. In other circumstances, output unit 406 may generate the output information using the rate information and not the position information, or output unit 406 may generate the output information using the any proportions of the position information and the rate information, respectively.

In another embodiment (not shown), output generation module 204 may implement a transfer function that generates the same output information as the embodiment of output generation module 204 shown in FIG. 4 without separately generating the position and rate information as shown in the embodiment of FIG. 4.

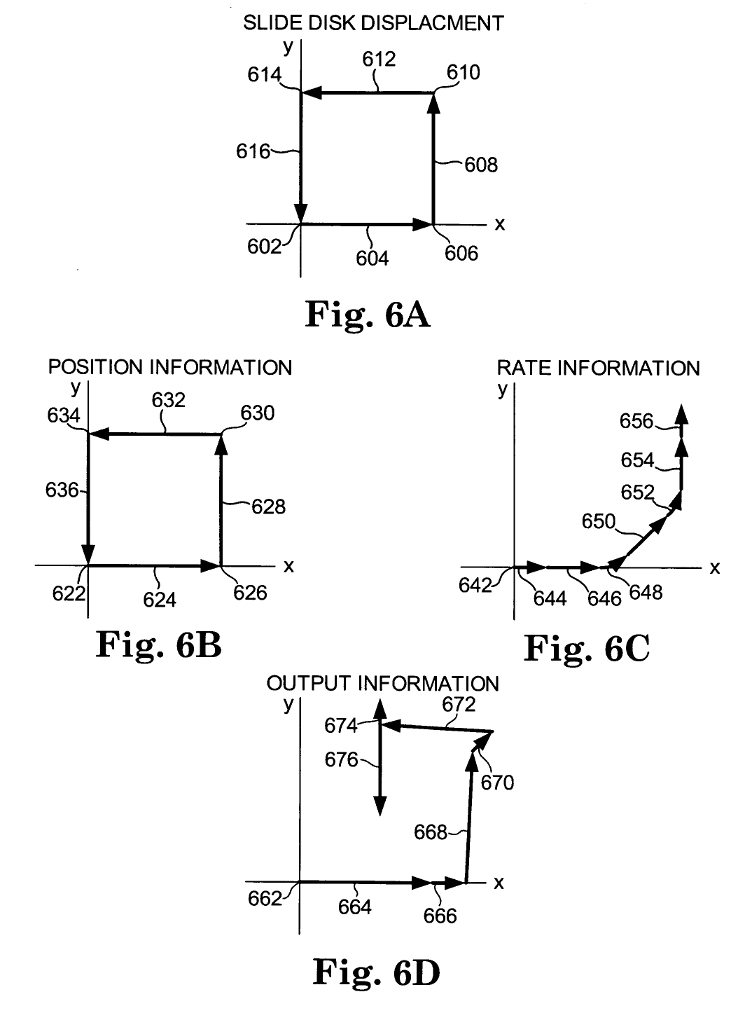

FIGS. 6A-6D are graphs illustrating an example of generating output information with slide pad system 10 using position information and rate information. FIG. 6A illustrates the displacement of slide disk 102 relative to frame 104 in the x and y directions over time. In the example of FIG. 6A, a user moves slide disk 102 from a center or neutral position 602 in the positive x direction as indicated by an arrow 604. The user pauses at position 606 before moving slide disk 102 in the positive y direction as indicated by an arrow 608. The user pauses at position 610 before moving slide disk 102 in the negative x direction as indicated by an arrow 612. The user pauses at position 614 before moving slide disk 102 in the negative y direction back to position 602 as indicated by an arrow 616.

FIG. 6B illustrates position information generated by position unit 402 based on the displacement of slide disk 102 shown in FIG. 6A. When slide disk 102 is at point 602, position unit 402 generates position information 622 that corresponds to the displacement of slide disk 102 at point 602. As slide disk 102 moves in the positive x direction as indicated by arrow 604, position unit 402 generates position information as shown along an arrow 624 that corresponds to the displacement of slide disk 102 as slide disk moves in the positive x direction. When slide disk 102 is at point 606, position unit 402 generates position information 626 that corresponds to the displacement of slide disk 102 at point 606. As slide disk 102 moves in the positive y direction as indicated by arrow 608, position unit 402 generates position information as shown along an arrow 628 that corresponds to the displacement of slide disk 102 as slide disk moves in the positive y direction. When slide disk 102 is at point 610, position unit 402 generates position information 630 that corresponds to the displacement of slide disk 102 at point 610. As slide disk 102 moves in the negative x direction as indicated by arrow 612, position unit 402 generates position information as shown along an arrow 632 that corresponds to the displacement of slide disk 102 as slide disk moves in the negative x direction. When slide disk 102 is at point 614, position unit 402 generates position information 634 that corresponds to the displacement of slide disk 102 at point 614. As slide disk 102 moves in the negative y direction as indicated by arrow 616, position unit 402 generates position information as shown along an arrow 636 that corresponds to the displacement of slide disk 102 as slide disk moves in the negative y direction.

FIG. 6C illustrates rate information generated by rate unit 404 based on the displacement of slide disk 102 shown in FIG. 6A. When slide disk 102 is at point 602, rate unit 404 generates rate information 642 that corresponds to the displacement of slide disk 102 at point 602. As slide disk 102 moves in the positive x direction as indicated by arrow 604, rate unit 404 generates rate information at various points along an arrow 644 that corresponds to the displacement of slide disk 102 as slide disk moves in the positive x direction. When slide disk 102 is at point 606, rate unit 404 generates rate information at various points along an arrow 646 that corresponds to the displacement of slide disk 102 at point 606. As slide disk 102 moves in the positive y direction as indicated by arrow 608, rate unit 404 generates rate information at various points along an arrow 648 that corresponds to the displacement of slide disk 102 as slide disk moves in the positive y direction. When slide disk 102 is at point 610, rate unit 404 generates rate information at various points along an arrow 650 that corresponds to the displacement of slide disk 102 at point 610. As slide disk 102 moves in the positive y direction as indicated by arrow 612, rate unit 404 generates rate information at various points along an arrow 652 that corresponds to the displacement of slide disk 102 as slide disk moves in the negative x direction. When slide disk 102 is at point 614, rate unit 404 generates rate information at various points along an arrow 654 that corresponds to the displacement of slide disk 102 at point 614. As slide disk 102 moves in the negative y direction as indicated by arrow 616, rate unit 404 generates rate information at various points along an arrow 656 that corresponds to the displacement of slide disk 102 as slide disk moves in the negative y direction.

FIG. 6D illustrates output information generated by output unit 406 using the position information shown in FIG. 6B and the rate information shown in FIG. 6C. In the example of FIG. 6D, output unit 406 generates output information by summing the position information and the rate information. Accordingly, output information 662 represents the sum of position information 622 and rate information 642. Output information along an arrow 664 represents the sum of position information along arrow 624 and rate information along arrow 644. Output information along an arrow 666 represents the sum of position information 626 and rate information along arrow 646. Output information along an arrow 668 represents the sum of position information along arrow 628 and rate information along arrow 648. Output information along an arrow 670 represents the sum of position information 630 and rate information along arrow 650. Output information along an arrow 672 represents the sum of position information along arrow 632 and rate information along arrow 652. Output information along an arrow 674 represents the sum of position information 634 and rate information along arrow 654. Output information along an arrow 676 represents the sum of position information along arrow 636 and rate information along arrow 656.

In the above example, position unit 402, rate unit 404, and output unit 406 may generate position, rate, and output information at any suitable cycle rate. Accordingly, position unit 402, rate unit 404, and output unit 406 may generate any number of instances of position, rate, and output information at each point and along each arrow shown in FIGS. 6A-6D. For example, each point and each arrow in FIG. 6A may represent five cycles in the operation of slide pad system 10. In this example, position unit 402 generates five instances of position information at each point and along each arrow shown in FIG. 6B, rate unit 404 generates five instances of rate information at each point and along each arrow shown in FIG. 6C, and output unit 406 generates five instances of output information at each point and along each arrow shown in FIG. 6D.

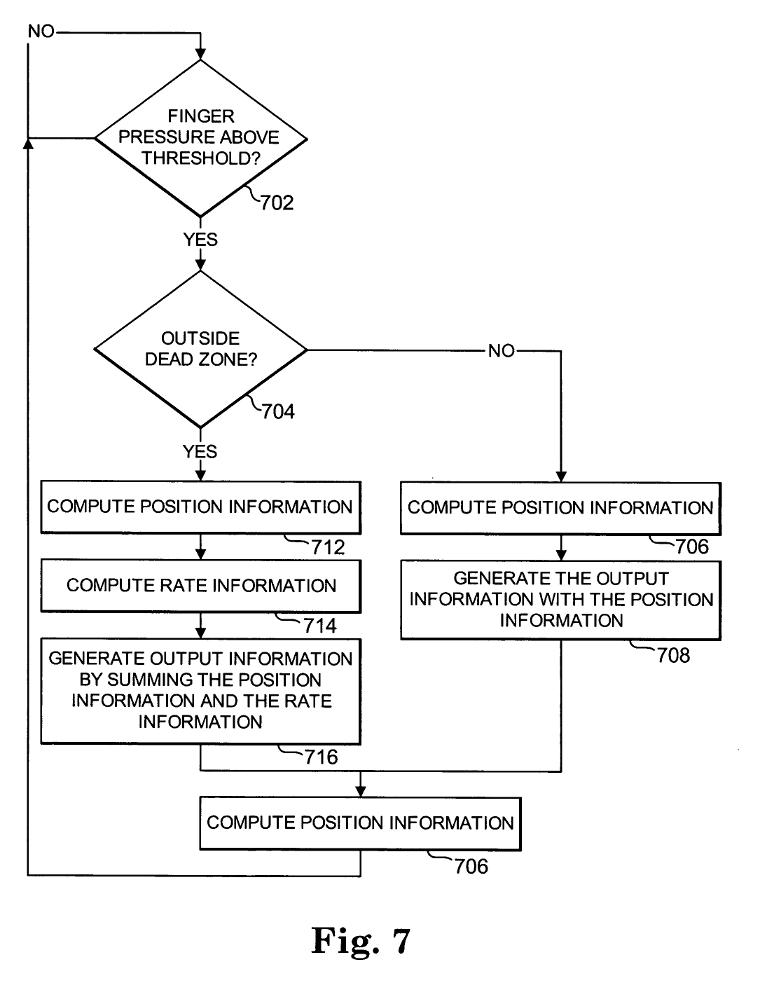

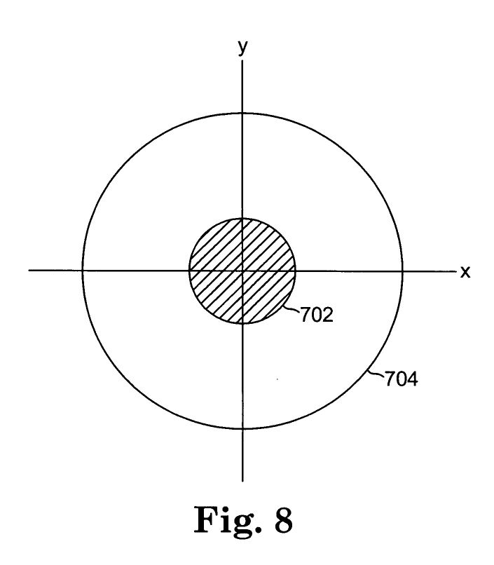

FIG. 7 is a flow chart illustrating another embodiment of a method for generating output information with slide pad system 10. The embodiment shown in FIG. 7 may be implemented using the embodiment shown in FIG. 2.

In the embodiment of FIG. 7, a determination is made by control unit 110 as to whether a finger pressure on slide disk 102 is above a threshold as indicated in a block 702. If the finger pressure on slide disk 102 is not above the threshold, then control unit 110 repeats the function of block 702. If finger pressure on slide disk 102 is above a threshold, then control unit 110 determines whether slide disk 102 is moved outside of a dead zone as indicated in a block 704.

FIG. 8 is a graph illustrating one embodiment of a dead zone. The dead zone is represented by a shaded region 702 where the displacement of slide disk 102 relative to frame 104 in the x and/or y directions is at or below the threshold represented by the outer edge of shaded region 702. A region 704 outside of the shaded region 702 represents the range of displacements of slide disk 102 relative to frame 104 such that the outer edge of shaded region 704 represents the maximum displacement of slide disk 102 in frame 104.

If slide disk 102 is not moved outside of a dead zone, then control unit 110 generates position information using the displacement of slide disk 102 relative to frame 104 as indicated in a block 706, and control unit 110 generates output information using only the position information, i.e., not the rate information, as indicated in a block 708. Control unit 110 provides the output information to host 220 as indicated in a block 710.

If slide disk 102 is moved outside of a dead zone, then control unit 110 generates position information using the displacement as indicated in a block 712. Control unit 110 generates rate information using the displacement as indicated in a block 714. Control unit 110 generates output information using the position information and the rate information as indicated in a block 716. Control unit 110 provides the output information to host 220 as indicated in block 710.

The method of FIG. 7 may be repeated either continuously in cycles (e.g., 120 Hz) or at selected times to generate updated output information and provide the updated output information to host 220. The selection state may be generated along with the output information in each cycle.

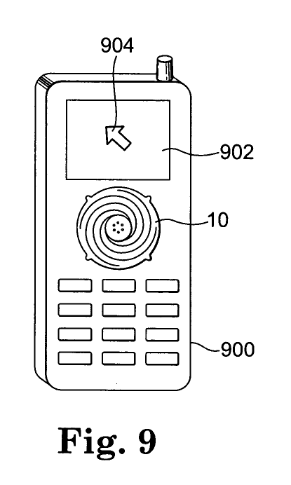

FIG. 9 is a schematic diagram illustrating one embodiment of a host 900 that includes a pointing system such as slide pad system 10. In the embodiment of FIG. 9, host 900 comprises a cellular or mobile telephone that includes a display 902 for displaying a pointer 904. A user of host 900 moves pointer 904 in display 902 using slide pad system 10. Host 900 is configured to operate pointer 904 in display 902 in accordance with the mouse, one-to-one, joystick, and hybrid modes of operation of slide pad system 10 as described above. In other embodiments, host 900 comprises an electronic device configured to perform other functions in addition to or in place of the functions of a cellular or mobile telephone.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method comprising:
detecting a first displacement of a slide disk relative to a frame; and
generating output information using first information configured to cause a pointer in a display to move to a position associated with the first displacement and second information configured to cause the pointer in the display to move at a velocity associated with the first displacement.

2. The method of claim 1 further comprising:
generating the first information; and
generating the second information.

3. The method of claim 2 further comprising:
generating the first information according to a first gain value; and
generating the second information according to a second gain value.

4. The method of claim 1 further comprising:
generating the output information by summing the first information and the second information.

5. The method of claim 1 wherein the first displacement is in a first direction that is substantially parallel with a hypothetical plane that includes the frame.

6. The method of claim 5 further comprising:
detecting a second displacement of the slide disk in a second direction that is substantially perpendicular to the hypothetical plane; and
generating the output information in response to the second displacement exceeding a threshold.

7. The method of claim 1 further comprising:
generating the output information using a first proportion of the first information and a second proportion of the second information.

8. The method of claim 7 wherein the first proportion and the second proportion vary with an amount of the first displacement.

9. The method of claim 7 wherein the second proportion is zero in response to the first displacement being below a threshold.

10. A system comprising:
a slide disk;
a frame; and
a control unit;
wherein the control unit is configured to generate output information using first information configured to map a first displacement of the slide disk relative to the frame to a position of a pointer in a display and second information configured to map the first displacement of the slide disk relative to the frame to a velocity of the pointer in the display.

11. The system of claim 10 wherein the control unit includes a sense module configured to detect the first displacement.

12. The system of claim 10 wherein the control unit includes a position unit, a rate unit, and an output unit, wherein the position unit is configured to generate the first information and provide the first information to the output unit, and wherein the rate unit configured to generate the second information and provide the second information to the output unit.

13. The system of claim 12 wherein the position unit is configured to generate the first information according to a first gain value, and wherein the rate unit is configured to generate the second information according to a second gain value.

14. The system of claim 11 wherein the control unit is configured to generate the output information by summing the first information and the second information.

15. The system of claim 11 wherein the first displacement is in a first direction that is substantially parallel with a hypothetical plane that includes the frame.

16. The system of claim 15 wherein the control unit includes a sense module configured to detect a second displacement of the slide disk in a second direction that is substantially perpendicular to the hypothetical plane and a control module configured to cause the output unit to generate the output information in response to the second displacement exceeding a threshold.

17. The system of claim 11 wherein the control unit is configured to generate the output information using a first proportion of the first information and a second proportion of the second information.

18. The system of claim 17 wherein the first proportion and the second proportion vary with an amount of the first displacement.

19. The system of claim 17 wherein the second proportion is zero in response to the first displacement being below a threshold.

20. A system comprising:
a display; and
a pointing system including a slide disk and a frame;
wherein the pointing system is configured to generate output information using first information configured to cause a pointer in the display to move to a position associated with a displacement of the slide disk relative to the frame and second information configured to cause the pointer in the display to move at a velocity associated with the displacement.
